(19) United States
(12) Patent Application Publication
(10) Pub. No.: US 2018/0013811 A1
(43) Pub. Date: Jan. 11, 2018

(54) DISPLAY SYSYEM, A SOURCE DEVICE, A SINK DEVICE AND AN IMAGE DISPLAYING METHOD

(71) Applicant: Novatek Microelectronics Corp., Hsinchu (TW)

(72) Inventors: Chih-Chia Kuo, Hsinchu County (TW); Chun Wang, Shanghai City (CN)

(21) Appl. No.: 15/203,806

(22) Filed: Jul. 7, 2016

(51) Int. Cl. H04L 29/06

(52) U.S. Cl. CPC H04L 65/602; H04L 65/607

(57) ABSTRACT

The display system adapted to provide a client oriented service is provided. The display system includes a source device and a sink device. The source device encodes a video input to output a video output. The video input includes video data. The video output includes metadata and a video stream, and the video stream is encoded from the video data. The sink device communicates with the source device. The sink device receives and decodes the video output to obtain the video data. The sink device displays images according to the video data and the metadata. The source device generates the metadata from the video input according to hardware parameters of the sink device. In addition, a source device, a sink device and an image displaying method are also provided.

### 1. FIELD OF THE INVENTION

The invention generally relates to a system, a device, and a display method, in particular, to a display system, a source device, a sink device and an image displaying method.

### 2. DESCRIPTION OF RELATED ART

Development of Over-The-Top (OTT) service is accelerating with advances in technologies. In recent years, electronic products applying Over-The-Top service become more and more diversified. Especially, the design of the display system, the source device and the sink device for providing the video service is more and more important. The sink device may be a television, a television box, a computer, a PAD, a smart phone, etc. However, the display quality of the current display system may be determined by the picture quality processing IC, panel and backlight of the sink device. The video data from the video input of the display system is standard signal, and the display system cannot optimize the sink device or video data to provide the good display quality. That is to say, the image quality for viewers depends on the capabilities of the device. Once the sink device does not support the video data, the sink device cannot display images according to the video data from the video input of the display system.

Hence, how to design a display system that could provide a good image display quality for users and a satisfactory user experience based on the different video data from the video source is one of the most important topics in the pertinent field.

### SUMMARY OF THE INVENTION

Accordingly, the invention is directed to a display system, a source device, a sink device, and an image display device, capable of providing a good image display quality for user and a satisfactory user experience.

The invention provides a display system. The display system is adapted to provide a client oriented service. The display system includes a source device and a sink device. The source device encodes a video input to output a video output. The video input includes video data. The video output includes metadata and a video stream, and the video stream is encoded from the video data. The sink device communicates with the source device. The sink device receives and decodes the video output to obtain the video data, and displays images according to the video data and the metadata. The source device generates the metadata from the video input according to hardware parameters of the sink device.

In an exemplary embodiment of the invention, the source device adjusts the video data according to the hardware parameters of the sink device.

In an exemplary embodiment of the invention, the source device performs a picture quality processing operation on the video input to generate the metadata from the video input according to a setting of a sink-like device. The setting of the sink-like device includes the hardware parameters of the sink device.

In an exemplary embodiment of the invention, the setting of the sink-like device is preset in a data processing unit or obtained from the sink device.

In an exemplary embodiment of the invention, the source device adjusts the setting of the sink-like device according to the hardware parameters of the sink device.

In an exemplary embodiment of the invention, the metadata includes a plurality of instructions to be applied to the video data. The source device generates the metadata by creating the instructions according to the hardware parameters of the sink device.

In an exemplary embodiment of the invention, the source device is adapted to provide the client oriented service for the sink device. The source device includes a data process unit, a data encoding unit, and a data merge unit. The data processing unit generates the metadata from the video input according to hardware parameters of the sink device. The data encoding unit is coupled to the data processing unit. The data encoding unit encodes the video data to generate the video stream. The data merge unit is coupled to the data encoding unit, and merges the video stream and the metadata to output a video output.

In an exemplary embodiment of the invention, the sink device outputs the hardware parameters to the source device based on a request of the source device.

In an exemplary embodiment of the invention, the metadata includes a plurality of instructions. The sink device applies the instructions to the video data, so as to perform the picture quality processing operation on the video data.

In an exemplary embodiment of the invention, the sink device is adapted to communicate with the source device. The sink device includes a data splitter unit, a data decoding unit, a data processing unit, and a display unit. The data splitter unit receives the video output outputted from the source device, and splits the video output to obtain the metadata and the video stream. The data decoding unit is coupled to the data splitter unit, and decodes the video stream to obtain the video data. The data processing unit is coupled to the data decoding unit, and performs a picture quality processing operation on the video data according to the metadata. The display unit is coupled to the data processing unit, and displays images according to the video data and the metadata.

The invention provides a source device. The source device is adapted to provide a client oriented service for a sink device. The source device includes a data processing unit, a data encoding unit, and a data merge unit. The data processing unit generates metadata from a video input according to hardware parameters of the sink device. The video input includes video data. The data encoding unit is coupled to the data processing unit, and encodes the video data to generate a video stream. The data merge unit is coupled to the data encoding unit, and merges the video stream and the metadata to output a video output.

In an exemplary embodiment of the invention, the data processing unit adjusts the video data according to the hardware parameters of the sink device.

In an exemplary embodiment of the invention, the data processing unit performs a picture quality processing operation on the video input to generate the metadata from the video input according to a setting of a sink-like device. The setting of the sink-like device includes the hardware parameters of the sink device.

In an exemplary embodiment of the invention, the setting of the sink-like device is preset in the data processing unit or obtained from the sink device.

In an exemplary embodiment of the invention, the data processing unit adjusts the setting of the sink-like device according to the hardware parameters of the sink device.

In an exemplary embodiment of the invention, the metadata includes a plurality of instructions to be applied to the video data. The data processing unit generates the metadata by creating the instructions according to the hardware parameters of the sink device.

The invention provides a sink device. The sink device is adapted to communicate with a source device. The sink device includes a data splitter unit, a data decoding unit, a data processing unit and a display unit. The data splitter unit receives a video output outputted from the source device, and splits the video output to obtain metadata and a video stream. The data decoding unit is coupled to the data splitter unit, and decodes the video stream to obtain video data. The data processing unit is coupled to the data decoding unit, and performs a picture quality processing operation on the video data according to the metadata. The metadata is generated according to hardware parameters of the sink device. The display unit is coupled to the data processing unit, and displays images according to the video data and the metadata.

In an exemplary embodiment of the invention, the data processing unit outputs the hardware parameters of the sink device to the source device based on a request of the source device, and the source device generates the metadata according to the hardware parameters of the sink device.

In an exemplary embodiment of the invention, the metadata includes a plurality of instructions. The data processing unit applies the instructions to the video data, so as to perform the picture quality processing operation on the video data.

The invention provides an image displaying method. The image displaying method is adapted to a display system including a source device and a sink device. The image displaying method includes the following steps: generating metadata from a video input according to hardware parameters of the sink device via the source device, where the video input includes video data; encoding the video data to generate a video stream by the source device, and merging the video stream and the metadata to output a video output to the sink device by the source device; and receiving and decoding the video output by the sink device, and displaying images according to the video data and the metadata by the sink device.

In an embodiment of the invention, the image displaying method further includes the following step: adjusting the video data according to the hardware parameters of the sink device by the source device.

According to the above descriptions, in the exemplary embodiments of the invention, the source device outputs the video output including the metadata and the video stream to the sink device according to hardware parameters of the sink device, where the video stream is encoded from the video data. The sink device decodes the video output to obtain the video data and the metadata, and displays images according the video data and the metadata. Therefore, the sink device adjusts the picture quality of the video data according to the metadata to provide a satisfactory image quality for users.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a workflow of a display system according to an embodiment of the invention.

FIG. 2 is a schematic diagram of a display system according to an embodiment of the invention.

FIG. 3 is a schematic diagram of a source device according to an embodiment of the invention.

FIG. 4 is a schematic diagram of a source device according to another embodiment of the invention.

FIG. 5 is a schematic diagram of a sink device according to an embodiment of the invention.

FIG. 6 is a flowchart illustrating steps of an image display method according to the embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments are provided below to describe the present disclosure in detail, though the present disclosure is not limited to the provided embodiments, and the provided embodiments can be suitably combined. The term “coupling/coupled” used in this specification (including claims) of the present application may refer to any direct or indirect connection means. For example, “a first device is coupled to a second device” should be interpreted as “the first device is directly connected to the second device” or “the first device is indirectly connected to the second device through other devices or connection means.” In addition, the term “signal” can refer to a current, a voltage, a charge, a temperature, data, electromagnetic wave or any one or multiple signals.

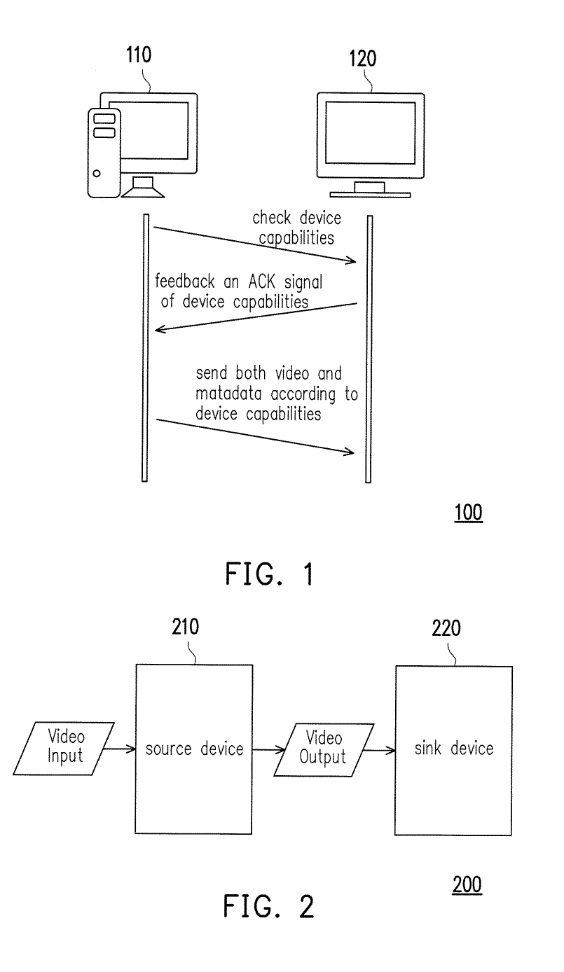

FIG. 1 illustrates a workflow of a display system according to an embodiment of the invention. Referring to FIG. 1, a display system 100 includes a source device 110 and a sink device 120. The source device 110 is configured to provide a video output to the sink device 120. The sink device 120 is configured to display images according to the video output. In the present embodiment, the display system 100 may apply to an Over-The-Top (OTT) service. The Over-The-Top service generally refers to the video services established on the network provided from the network operator. That is to say, the display system 100 may be configured to provide the delivery of audio, video and other media over the internet. Therefore, the source device 110 may be an open-source video platform or device, and configured to provide video data for the display unit of the sink device 120 by internet. In the present embodiment, the sink device 120 may be a hardware having display functions, such as a television, a television box, computer, a laptop computer, a smart device, a mobile telephone, a tablet device, or some other appliances that receive video data and display images by the broadcast, Over-The-Top (OTT) service, High Definition Multimedia Interface (HDMI), or some other transmission for wireless or wired connection of the internet. The invention is not limited thereto.

To be specific, in the present embodiment, the display system 100 may be a display ecosystem system, and configured to perform an optimization for display quality according to different video sources. That is to say, the display system 100 may be designed for provide a client oriented service. In the present embodiment, the source device 110 may generate metadata for the image optimization according to the device capabilities of the sink device 120, so that at least one of the source device 110 and the sink device 120 may adjust the video data to provide a good display quality according to the device capabilities of the sink device 120. In the present embodiment, the sink device 120 may adjust the video data or the device capabilities itself based on the metadata. In the present embodiment, the video data may be encoded by Advanced Video Coding (AVC), High Efficiency Video Coding (HEVC) or other video coding methods, which the invention is not limited thereto.

More specifically, when a user operates the sink device 120 to view an image, the source device 110 may output a signal to the sink device 120 to check the device capabilities of the sink device 120. Then, the sink device 120 may feedback an acknowledgement signal (ACK) to provide hardware parameters of the sink device 120 to the source device 110. Therefore, the source device 110 may send a video output including a video stream and metadata to the sink device 120 according to the hardware parameters of the sink device 120. The video stream is encoded from the video data. In the present embodiment, the sink device 120 may decode the video output to obtain the video data and the metadata, and perform a picture quality processing operation on the video data according to the metadata. That is to say, the source device 110 may generate a video output adapted for the sink device 120, such that the sink device 120 provides a good display quality according to the hardware condition itself.

FIG. 2 is a schematic diagram of a display system according to an embodiment of the invention. Referring to FIG. 2, a display system 200 includes a source device 210 and a sink device 220. The source device 210 is configured to encode a video input to output a video output. The video input includes video data. The sink device 220 communicates with the source device 210, and is configured to receive and decode the video output. In the present embodiment, the video output includes metadata and a video stream. The video stream is encoded from the video data. The sink device 220 decodes the video output to obtain the video data, and displays images according to the video data and the metadata. However, in one embodiment, the source device 210 may also adjust the video data according to the hardware parameters of the sink device 220.

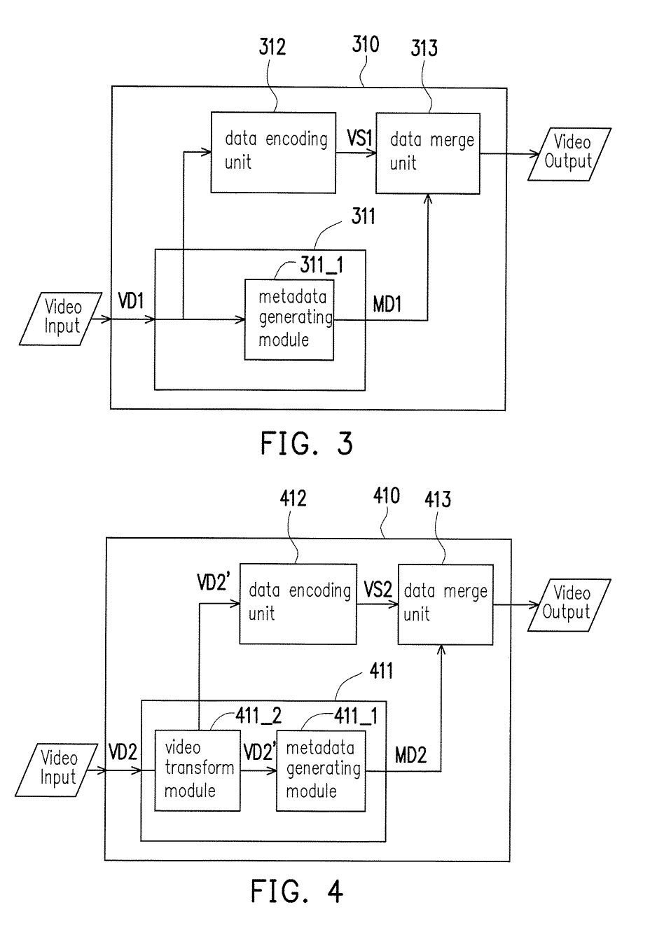

FIG. 3 is a schematic diagram of a source device according to an embodiment of the invention. In the exemplary embodiment of the invention, the above source device may be a source device 310 of FIG. 3. Referring to FIG. 2 and FIG. 3, a source device 310 includes a data processing unit 311, a data encoding unit 312 and a data merge unit 313. The source device 310 is adapted to communicate with a sink device. In the present embodiment, the data processing unit 311 is configured to generate metadata MD1 from a video input according to hardware parameters of the sink device. The data encoding unit 312 is coupled to the data processing unit 311, and configured to encode the video data VD1 to generate the video stream VS1. The data merge unit 313 is coupled to the data encoding unit 312, and configured to merge the video stream VS1 and the metadata MD1 to output a video output.

In the present embodiment, the data processing unit 311 may include a metadata generating module 311_1. The metadata generating module 311_1 may be configured to perform a picture quality processing operation on the video input to generate the metadata MD1 from the video input according to a setting of a sink-like device. The setting of the sink-like device includes the hardware parameters of the sink device. That is to say, the data processing unit 311 generates the metadata MD1 by creating the instructions according to the hardware parameters of the sink device.

In the present embodiment, the setting of the sink-like device may be preset in the data processing unit 311 or obtained from the sink device. Moreover, the data processing unit 311 may also adjust the setting of the sink-like device according to the hardware parameters of the sink device. It should be noticed that, the hardware parameters for display quality optimization may include a plurality of instruction to be applied to the video data, and the plurality of instructions may include per scene contrast distribution, per scene content color gamut, motion vectors, scene changes, depth maps, noise levels, film cadences, logos (for OLED burn in protection), or luminance profiles (for local dimming and boosting), and so on, which are not limited in the invention.

For example, owing to the sink device cannot utilize the video data VD1 of the video input to display the image, or the setting of the sink-like device is not preset in the data processing unit 311, the source device 310 may determine the metadata MD1 according to the device capabilities of the sink device, and encode the video output according to the video data VD1 and the metadata MD1 to output to the sink device. Therefore, in the present embodiment, the sink device receiving the video output may adjust the video data VD1 or the hardware parameters itself according to the metadata MD1, so that the sink device is able to display image according to the video data.

Besides, in the present embodiment, the processing unit 311 includes, for example, a Central Processing Unit (CPU), a Microprocessor, a Digital Signal Processor (DSP), a Programmable Controller, a Programmable Logic Device (PLD), or other similar devices, a combination of the foregoing devices, which are not particularly limited in the present invention. In the present embodiment, the data encoding unit 312 may include any encoder circuit or combiner circuit in the related art or be implemented by using any encoder circuit or combiner circuit in the related art, and the data merge unit 313 may include any adder circuit or mixer circuit in the related art or be implemented by using any adder circuit or mixer circuit in the related art, which are not particularly limited in the invention. Alternatively, in one embodiment, at least one of the data encoding unit 312 and the data merge unit 313 in FIG. 3 may also be implemented as a plurality of program codes. These program codes will be stored in one memory, so that these program codes may be executed by the processing unit 311 or any other processor. The disclosure is not intended to limit whether the data encoding unit 312 and the data merge unit 313 are implemented by ways of software or hardware.

FIG. 4 is a schematic diagram of a source device according to another embodiment of the invention. In the exemplary embodiment of the invention, the above source device may also be a source device 410 of FIG. 4. Referring to FIG. 2 and FIG. 4, the source device 410 includes a data processing unit 411, a data encoding unit 412 and a data merge unit 413. The source device 410 is adapted to communicate with a sink device.

In the present embodiment, the data processing unit 411 includes a metadata generating module 411_1 and a video transform module 411_2. The video transform module 411_2 is configured to perform an image optimization operation on the video data VD2 to generate video data VD2′ adapted for the sink device. The metadata generating module 411_1 is configured to generate the metadata MD2 according to the video data VD2′ from the video input according to a setting of a sink-like device. The setting of a sink-like device includes the hardware parameters of the sink device. That is to say, the data processing unit 411 may pre-adjust the video input VI2 according the device capabilities of the sink device, and generate the metadata MD2 by creating the instructions according to the hardware parameters of the sink device.

For example, the source device 410 may pre-storage the information of the display format. When the source device 410 receives the video input having the video data VD2, the source device 410 may pre-adjust the video data VD2 to obtain the video data VD2′ adapted for the sink device according to the setting of the sink-like device, and encode the video data VD2′ to obtain the video stream VS2. Then, the source device 410 determines the metadata MD2 according to the device capabilities of the sink device, and encodes the video output according to the video stream VS2 and the metadata MD2 to output to the sink device. Therefore, the sink device receiving the video output may adjust the video data VD2′ again or adjust the hardware parameters itself according to the metadata MD2.

Besides, in the present embodiment, the data processing unit 411, the data encoding unit 412 and the data merge unit 413 described in the present embodiment of the invention is sufficiently taught, suggested, and embodied in the embodiments illustrated in FIG. 3, and therefore no further description is provided herein.

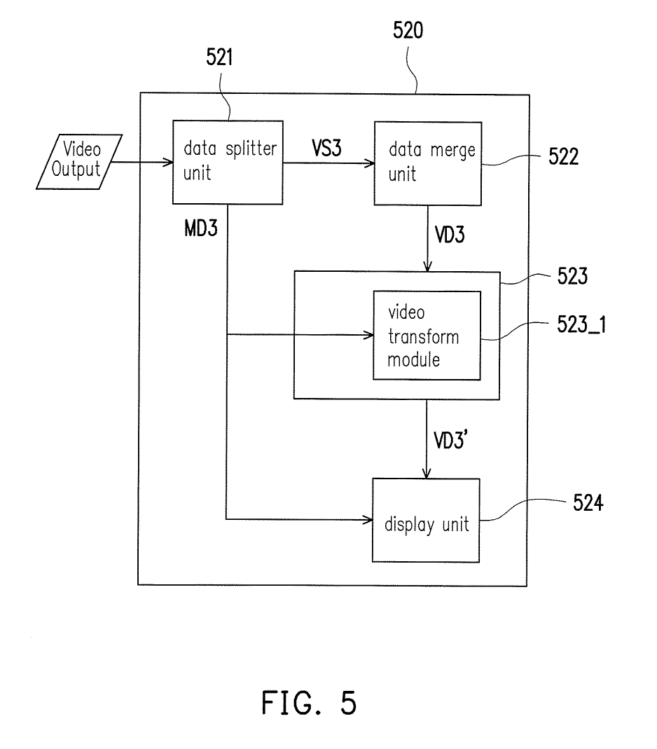

FIG. 5 is a schematic diagram of a sink device according to an embodiment of the invention. In the exemplary embodiment of the invention, the above sink device may be a sink device 520 of FIG. 5. Referring to FIG. 2 and FIG. 5, the sink device 520 includes a data splitter unit 521, a data decoding unit 522, a data processing unit 523 and a display unit 524. The sink device 520 is adapted to communicate with a source device. In the present embodiment, the data splitting unit 521 is configured to receive a video output from the source device, and split the video output to obtain metadata MD3 and a video stream VS3. The data decoding unit 522 is coupled to the data splitter unit 521, and configured to decode the video stream VS3 to obtain video data VD3. The data processing unit 523 is coupled to the data decoding unit 522, and configured to adjust the video data VD3 to generate video data VD3′ according to the metadata MD3. The display unit 524 is coupled to the data processing unit 523, and configured to display images according to the video data VD3′ and the metadata MD3. In the present embodiment, the display unit 524 may perform an optimization for display quality through a system on chip (SoC), a panel, or a backlight of the display unit 524 according to the metadata MD3. In addition, the video data VD3 may be an original video data from the video input of the video system or may be pre-adjusted by the source device.

In the present embodiment, the data processing unit 523 may further include a video transform module 523_1. Owing to the metadata MD3 may include a plurality of instructions, and the data processing unit 523 applies the instructions to the video data VD3, the video transform module 523_1 may perform a picture quality processing operation on the video data VD3 to generate the video data VD3′ according to the metadata MD3 according to the hardware parameters of the sink device 520.

In addition, in one embodiment, the data processing unit 523 may output the hardware parameters of the sink device 520 to the source device based on a request of the source device, so that the source device may generate the metadata according to the hardware parameters of the sink device.

Besides, in the present embodiment, the data processing unit 523 includes, for example, a Central Processing Unit (CPU), a Microprocessor, a Digital Signal Processor (DSP), a Programmable Controller, a Programmable Logic Device (PLD), or other similar devices, a combination of the said devices, which are not particularly limited by the present invention. In the present embodiment, the data splitter unit 521 may include any splitter circuit or separator circuit in the related art or be implemented by using any splitter circuit or separator circuit in the related art, and the data decoding unit 522 may include any decoder circuit in the related art or be implemented by using any decoder circuit in the related art, which are not particularly limited by the invention. Alternatively, in one embodiment, at least one of the data splitter unit 521 and the data decoding unit 522 in FIG. 5 may also be implemented as a plurality of program codes. These program codes will be stored in a memory, so that these program codes may be executed by data processing unit 523 or any other processor. The disclosure is not intended to limit whether the data splitter unit 521 and the data decoding unit 522 are implemented by ways of software or hardware.

Furthermore, in the present embodiment, the display unit 524 may be a Liquid Crystal Display (LCD) device, a Plasma Display Panel (PDP) device, an Organic Light Emitting Display (OLED) device, a Field Emission. Display (FED) device, an Electro-Phoretic Display (EPD) device or a Light Emitting Diode (LED) display and the like, which are also not limited in the invention.

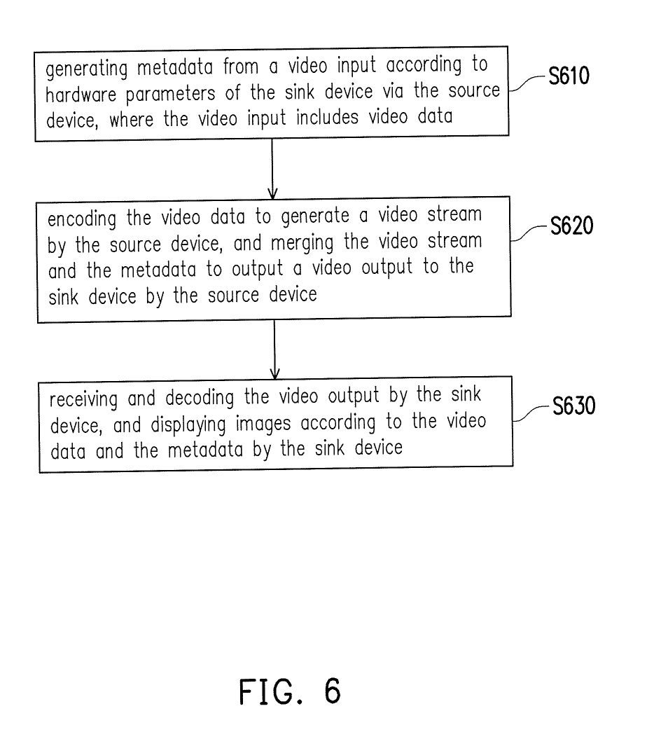

FIG. 6 is a flowchart illustrating steps of an image display method according the embodiment of the invention. Referring to FIG. 2 and FIG. 6, the image displaying method is at least adapted to the display system 200 in FIG. 2, but the invention is not limited thereto. In the present embodiment, the display system 200 includes the source device 210 and the sink device 220. The image displaying method at least includes the following steps. In step S610, the source device 210 generates metadata from a video input according to hardware parameters of the sink device 220 via the source device 210. The video input includes video data. In step S620, the source device 210 encodes the video data to generate a video stream by the source device 210, and merges the video stream and the metadata to output a video output to the sink device by the source device. In step S630, the sink device 220 receives and decodes the video output by the sink device, and displays images according to the video data and the metadata by the sink device. Besides, the image display method described in the present embodiment of the invention is sufficiently taught, suggested, and embodied in the embodiments illustrated in FIG. 1 to FIG. 5, and therefore no further description is provided herein.

In summary, in the exemplary embodiment of the invention, the display system may adjust the video data according to the device capabilities of the sink device to provide a good display quality for user. The display system may utilize the source device or the sink device to perform a picture quality processing operation according to the device capabilities of the sink device, so as to adjust the video data from the video input of video system. Accordingly, the display system of the exemplary embodiments of the invention may provide a good image display quality for a specific sink device or a non-specific sink device, and reduce the processing time of the video data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display system, adapted to provide a client oriented service, and comprising:
a source device, encoding a video input to output a video output, wherein the video input comprises video data, the video output comprises metadata and a video stream, and the video stream is encoded from the video data; and
a sink device, communicating with the source device, receiving and decoding the video output to obtain the video data, and displaying images according to the video data and the metadata,
wherein the source device generates the metadata from the video input according to hardware parameters of the sink device.

2. The display system according to claim 1, wherein the source device adjusts the video data according to the hardware parameters of the sink device.

3. The display system according to claim 1, wherein the source device performs a picture quality processing operation on the video input to generate the metadata from the video input according to a setting of a sink-like device, wherein the setting of the sink-like device comprises the hardware parameters of the sink device.

4. The display system according to claim 3, wherein the setting of the sink-like device is preset in a data processing unit or obtained from the sink device.

5. The display system according to claim 3, wherein the source device adjusts the setting of the sink-like device according to the hardware parameters of the sink device.

6. The display system according to claim 1, wherein the metadata comprises a plurality of instructions to be applied to the video data, and the source device generates the metadata by creating the instructions according to the hardware parameters of the sink device.

7. The display system according to claim 1, wherein the source device is adapted to provide the client oriented service for the sink device, and the source device comprises:
a data processing unit, generating the metadata from the video input according to hardware parameters of the sink device;
a data encoding unit, coupled to the data processing unit, and encoding the video data to generate the video stream; and
a data merge unit, coupled to the data encoding unit, and merging the video stream and the metadata to output a video output.

8. The display system according to claim 1, wherein the sink device outputs the hardware parameters to the source device based on a request of the source device.

9. The display system according to claim 1, wherein the metadata comprises a plurality of instructions, and the sink device applies the instructions to the video data, so as to perform the picture quality processing operation on the video data.

10. The display system according to claim 1, wherein the sink device is adapted to communicate with the source device, and comprising:
a data splitter unit, receiving the video output outputted from the source device, and splitting the video output to obtain the metadata and the video stream;
a data decoding unit, coupled to the data splitter unit, and decoding the video stream to obtain the video data;
a data processing unit, coupled to the data decoding unit, and performs a picture quality processing operation on the video data according to the metadata; and
a display unit, coupled to the data processing unit, and displaying images according to the video data and the metadata.

11. A source device, adapted to provide a client oriented service for a sink device, and comprising:
a data processing unit, generating metadata from a video input according to hardware parameters of the sink device, wherein the video input comprises video data;
a data encoding unit, coupled to the data processing unit, and encoding the video data to generate a video stream; and
a data merge unit, coupled to the data encoding unit, and merging the video stream and the metadata to output a video output.

12. The source device according to claim 11, wherein the data processing unit adjusts the video data according to the hardware parameters of the sink device.

13. The source device according to claim 11, wherein the data processing unit performs a picture quality processing operation on the video input to generate the metadata from the video input according to a setting of a sink-like device, wherein the setting of the sink-like device comprises the hardware parameters of the sink device.

14. The source device according to claim 13, wherein the setting of the sink-like device is preset in the data processing unit or obtained from the sink device.

15. The source device according to claim 13, wherein the data processing unit adjusts the setting of the sink-like device according to the hardware parameters of the sink device.

16. The source device according to claim 11, wherein the metadata comprises a plurality of instructions to be applied to the video data, and the data processing unit generates the metadata by creating the instructions according to the hardware parameters of the sink device.

17. A sink device, adapted to communicate with a source device, and comprising:
a data splitter unit, receiving a video output outputted from the source device, and splitting the video output to obtain metadata and a video stream;
a data decoding unit, coupled to the data splitter unit, and decoding the video stream to obtain video data;
a data processing unit, coupled to the data decoding unit, and performs a picture quality processing operation on the video data according to the metadata, wherein the metadata is generated according to hardware parameters of the sink device; and
a display unit, coupled to the data processing unit, and displaying images according to the video data and the metadata.

18. The sink device according to claim 17, wherein the data processing unit outputs the hardware parameters of the sink device to the source device based on a request of the source device, and the source device generates the metadata according to the hardware parameters of the sink device.

19. The sink device according to claim 17, wherein the metadata comprises a plurality of instructions, and the data processing unit applies the instructions to the video data, so as to perform the picture quality processing operation on the video data.

20. An image displaying method, adapted to a display system comprising a source device and a sink device, and comprising:
generating metadata from a video input according to hardware parameters of the sink device via the source device, wherein the video input comprises video data;
encoding the video data to generate a video stream by the source device, and merging the video stream and the metadata to output a video output to the sink device by the source device; and
receiving and decoding the video output by the sink device, and displaying images according to the video data and the metadata by the sink device.

21. The image displaying method according to claim 20, further comprising:
adjusting the video data according to the hardware parameters of the sink device by the source device.
